(19) United States
(12) Patent Application Publication
(10) Pub. No.: US 2007/0103596 A1
(43) Pub. Date: May 10, 2007

(54) Method of using matrix to adjust hue and color saturation

(75) Inventor: Chin-Fu Hsu, Hsinchu (TW)

Correspondence Address: TROXELL LAW OFFICE PLLC;ONE SKYLINE PLACE, SUITE 1404, 5205 LEESBURG PIKE, FALLS CHURCH, VA, 22041, US

(73) Assignee: CHEERTEK INC.

(21) Appl. No.: 11/331,125

(22) Filed: Jan. 13, 2006

(30) Foreign Application Priority Data
Nov. 7, 2005 (TW) 094138919

(51) Int. Cl. H04N 9/66

(52) U.S. Cl. 348/649; 348/638

(57) ABSTRACT

A method of using matrix to adjust hue and color saturation includes the following steps: transform a YUV format signal into a RGB format signal with a first matrix; the RGB format signal is multiplied by a second matrix to obtain a RGB format signal whose hue and/or color saturation can be adjusted.

### FIELD OF THE INVENTION

The present invention relates to a method of using matrix to hue and color saturation, and particularly to a method of using matrix to adjust hue and color saturation, which can simplify the complexity of chip design and reduce chip size to cut the cost of producing chip.

### BACKGROUND OF THE INVENTION

The format of the video signal of LCD TV is YUV, but that of the video signal for the display in a thin-film transistor (TFT) liquid crystal panel is RGB. Consequently, there is a built-in circuit in the video signal decoder to transform the video signal format from YUV to RGB.

FIG. 2 is a schematic illustration of the circuits for transforming a LUV format signal to a RGB format signal and for adjusting hue and color saturation of a conventional video signal decoder. Referring to FIG. 2, apart from a circuit for transforming a video signal from LUV format to a RGB format, the video signal decoder is also provided with a circuit to adjust hue and color saturation. The circuit adjusting hue and color saturation uses a sinusoidal circuit, a cosine circuit, an adder, and a multiplier to adjust hue and color saturation. However, the complicated nature of sinusoidal and cosine circuits has increased the difficulty in chip design and chip size and thus the cost of producing chip.

To overcome the shortcoming of the aforementioned conventional circuit for adjusting hue and color saturation, it is necessary to have a method of using matrix to adjust hue and color saturation, which can simplify the complexity of chip design and reduce chip size to cut the cost of producing chip.

### SUMMARY OF THE INVENTION

It is an object of the present invention to provide a method of using matrix to adjust hue and color saturation, which uses matrix to adjust hue and color saturation. The method can simplify the complexity of chip design and reduce chip size to cut the cost of producing chip.

It is an object of the present invention to provide a method of using matrix to adjust hue and color saturation, including the following steps: transform a YUV format signal into a RGB format signal with a first matrix; the RGB format signal is multiplied by a second matrix to obtain a RGB format signal whose hue and/or color saturation can be adjusted.

### BRIEF DESCRIPTION OF THE DRAWINGS

The present invention can be more fully understood by reference to the following description and accompanying drawings, in which:

FIG. 1 is a flow chart for a method of using matrix to adjust hue and color saturation according to the present invention; and

FIG. 2 is a schematic illustration of the circuits for transforming a LUV format signal to a RGB format signal and for adjusting hue and color saturation of a conventional video signal decoder.

### DETAILED DESCRIPTION OF THE INVENTION

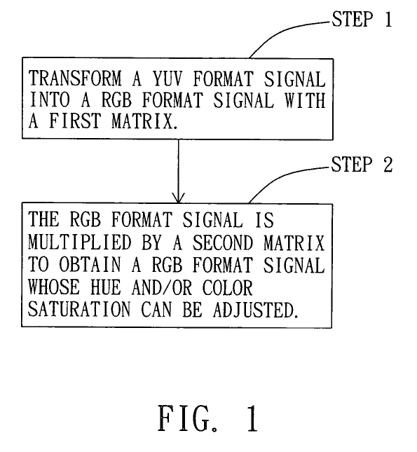

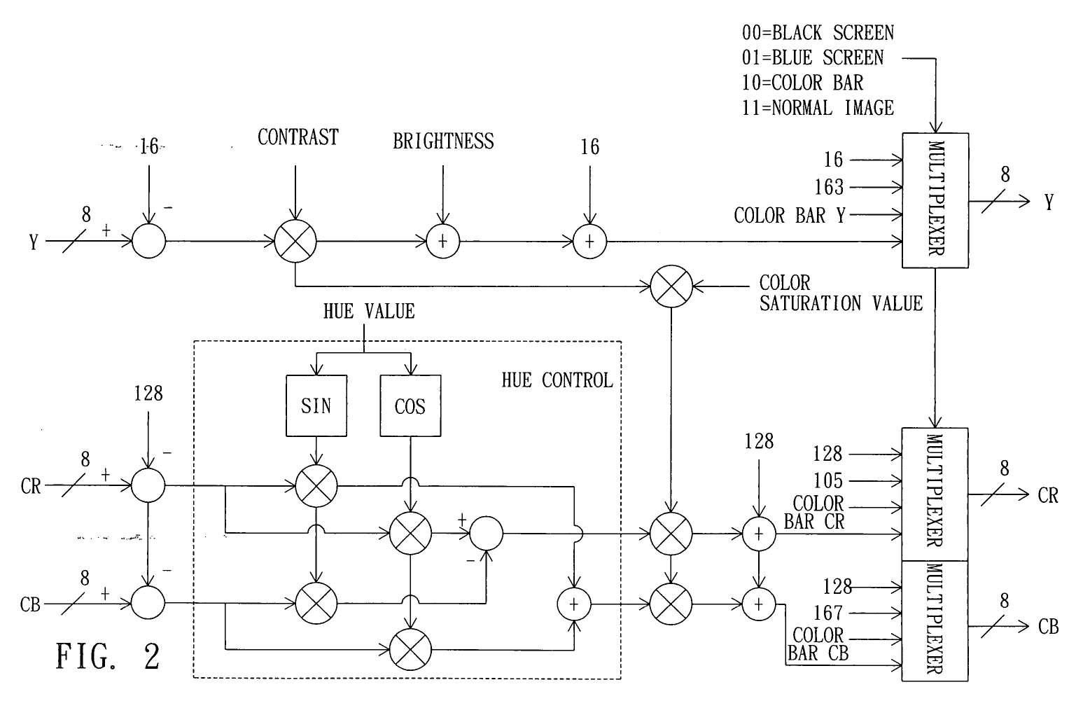

FIG. 1 is a flow chart for a method of using matrix to adjust hue and color saturation according to the present invention. Referring to FIG. 2, the method of using matrix to adjust hue and color saturation according to the present invention is applicable in an electric appliance, which is, for example, but not limited to, a LCD TV, a portable audio/video displayer/recorder, or a digital set top box, including the following steps: transform a YUV format signal into a RGB format signal with a first matrix (step 1); the RGB format signal is multiplied by a second matrix to obtain a RGB format signal whose hue and/or color saturation can be adjusted (step 2).

In the step 1, the equations for the first matrix which transforms a YUV format signal into a RGB format signal are:
R=Y+1.140V (equation 1)
G=Y−0.395U−0.581V (equation 2)
B=Y+2.032U (equation 3)

Rearrange equations 1 to 3 can lead to the first matrix, whose coefficients are:

$$[ \begin{matrix}1 & 0 & 1.140 \\ 1 & - 0.395 & - 0.581 \\ 1 & 2.032 & 0\end{matrix} ]$$

Consequently, the matrix expression for using the first transformation matrix (a 3×3 matrix) described above to transform a YUV format signal to a RGB format signal can be written as:

$$[ \begin{matrix}R \\ G \\ B\end{matrix} ] = [ \begin{matrix}1 & 0 & 1.140 \\ 1 & - 0.395 & - 0.581 \\ 1 & 2032 & 0\end{matrix} ] \times [ \begin{matrix}Y \\ U \\ V\end{matrix} ] . \qquad ( equation 4 )$$

In the step 2, the RGB format signal is multiplied by a second matrix to obtain a RGB format signal whose hue and/or color saturation can be adjusted. The second transformation matrix is a 3×3 matrix, whose coefficients are:

$$[ \begin{matrix}1 & 0 & 0 \\ 0 & cos ( hue ) * Sat & - sin ( hue ) * Sat \\ 0 & sin ( hue ) * Sat & cos ( hue ) * Sat\end{matrix} ]$$

Consequently, the matrix expression for using the second transformation matrix (a 3×3 matrix) described above to adjust the hue and color saturation of a RGB format can be written as:

$$[ \begin{matrix}R \\ G \\ B\end{matrix} ] [ \begin{matrix}1 & 0 & 1.140 \\ 1 & - 0.395 & - 0.581 \\ 1 & 2.032 & 0\end{matrix} ] \times \\ [ \begin{matrix}1 & 0 & 0 \\ 0 & cos ( hue ) * Sat & - sin ( hue ) * Sat \\ 0 & sin ( hue ) * Sat & cos ( hue ) * Sat\end{matrix} ] \times [ \begin{matrix}Y \\ U \\ V\end{matrix} ] \qquad ( equation 5 )$$

where the parameter Sat represents color saturation, whose range is 0˜1.992. Consequently, after the matrix operation of the equation 5 described above, a YUV format signal can be transformed into a RGB format signal and its hue and/or color saturation can be adjusted by the second transformation matrix. The aforementioned matrix multiplication can be achieved by executing a software program, which can be, for example, but not limited to C or C++. Chip designers need only to modify the parameters of hue and color saturation by a program language to adjust hue and color saturation. Consequently, the method of using matrix to adjust hue and color saturation according to the present invention can eliminate the need for a sinusoidal circuit, a cosine circuit, an adder, and a multiplier. Therefore, the method of using matrix to adjust hue and color saturation according to the present invention can simplify the complexity of chip design and reduce chip size to cut the cost of producing chip.

A learning method of using matrix to adjust hue and color saturation according to the present invention is described above. The method can simplify the complexity of chip design and reduce chip size to cut the cost of producing chip. These advantages are not possible to achieve with the prior art. Consequently, it can indeed improve the shortcoming of using circuit to adjust hue and color saturation.

While the invention has been described with reference to the a preferred embodiment thereof, it is to be understood that modifications or variations may be easily made without departing from the spirit of this invention, which is defined by the appended claims.

What is claimed is:

1. A method of using matrix to adjust hue and color saturation, comprising the following steps:
transform a YUV format signal into a RGB format signal with a first matrix; and
the RGB format signal is multiplied by a second matrix to obtain a RGB format signal whose hue and/or color saturation can be adjusted.

2. The method of claim 1, wherein the first transformation matrix is a 3×3 matrix.

3. The method of claim 2, the 3×3 matrix's coefficients are:
$$[ \begin{matrix}1 & 0 & 1.140 \\ 1 & - 0.395 & - 0.581 \\ 1 & 2.032 & 0\end{matrix} ] .$$

4. The method of claim 1, wherein the second transformation matrix is a 3×3 matrix.

5. The method of claim 4, wherein the 3×3 matrix's coefficients are:
$$[ \begin{matrix}1 & 0 & 0 \\ 0 & cos ( hue ) * Sat & - sin ( hue ) * Sat \\ 0 & sin ( hue ) * Sat & cos ( hue ) * Sat\end{matrix} ] .$$

6. The method of claim 5, the value of hue is 0˜360°.

7. The method of claim 5, the value of color saturation is 0˜1.992.
